(19) United States
(12) Patent Application Publication
(10) Pub. No.: US 2021/0276509 A1
(43) Pub. Date: Sep. 9, 2021

(54) AIRBAG ARRANGEMENT STRUCTURE

(71) Applicant: HONDA MOTOR CO., LTD., Tokyo (JP)

(72) Inventors: Seiji KOBATA, Wako-shi (JP); Yuya OBAYASHI, Wako-shi (JP); Kenshi TORIKAI, Wako-shi (JP)

(21) Appl. No.: 17/184,847

(22) Filed: Feb. 25, 2021

(30) Foreign Application Priority Data
Mar. 5, 2020 (JP) 2020-038153

(51) Int. Cl. B60R 21/36; B60R 21/38

(52) U.S. Cl. CPC B60R 21/36; B60R 21/38

(57) ABSTRACT

An airbag arrangement structure prevents interference from devices in an engine room. The airbag arrangement structure includes: a hood configured to open or close an opening above an engine room provided in front of a vehicle interior; a cover provided under the hood so as to face the hood; and an airbag provided between the hood and the cover.

### CROSS-REFERENCE TO RELATED APPLICATION

This application claims the benefit of priority to Japanese Patent Application No. 2020-038153 filed on 5 Mar. 2020, the disclosures of all of which are hereby incorporated by reference in their entireties.

### TECHNICAL FIELD

The present invention relates to an airbag arrangement structure of a vehicle.

### BACKGROUND OF THE INVENTION

Japanese Patent Application Publication No. H07-156749 (hereinafter, referred to as Patent Document 1) discloses a device having a lid provided on a hood of a vehicle and deploying an airbag from the lid onto a periphery of the hood. In addition, Japanese Patent Application Publication No. 2005-212541 (hereinafter, referred to as Patent Document 2) discloses a device having an airbag provided at a cowl of a vehicle body and utilizing a deploying force of the airbag to lift a rear end of a bonnet hood, which is the farthest portion from a bonnet lock as a rotation axis.

### SUMMARY OF THE INVENTION

### Problems to be Solved

The device of Patent Document 1 needs to have the lid provided on the hood, and it takes time to deploy the airbag along the periphery of the hood after the airbag has bulged out of the vehicle. In addition, the device of Patent Document 2 can lift only the rear end of the bonnet hood (the farthest portion from the bonnet lock). If the airbag of the device were used to lift the middle or a front end in a front-rear direction of the bonnet hood, the airbag might have interference from devices in an engine room to fail to be suitably inflated.

The present invention has been made in view of the above-identified problems and is intended to provide an airbag arrangement structure to prevent interference from devices in an engine room.

### Solution to Problem

An airbag arrangement structure of the present invention, as a solution to the above-identified problem, includes: a hood configured to open or close an opening above an engine room provided in front of a vehicle interior; a cover provided under the hood so as to face the hood; and an airbag provided between the hood and the cover.

### Advantageous Effects of the Invention

The present invention uses the cover to prevent the deploying airbag from having interference from devices in the engine room.

### BRIEF DESCRIPTION OF DRAWINGS

FIG. 1 is a schematic side view of a vehicle having an airbag arrangement structure according to an embodiment of the present invention;

FIG. 2 is a schematic perspective view of the airbag arrangement structure according to the embodiment of the present invention;

FIG. 3 is an exploded schematic perspective view of the airbag arrangement structure according to the embodiment of the present invention;

FIG. 4 is a schematic perspective view of a hinge before deformation;

FIG. 5 is a schematic perspective view of the hinge after deformation;

FIG. 6 is a schematic perspective view of a striker; and

FIG. 7 is a schematic perspective view of the vehicle, with the deployed airbag.

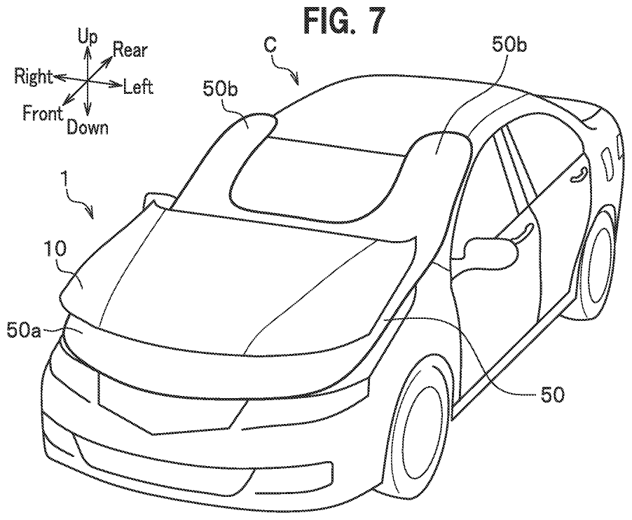

### EMBODIMENTS OF THE INVENTION

Next, an embodiment of the present invention is described in detail with reference to drawings as required. Note that a term “front-rear” indicates a vehicle front-rear direction, a term “right-left” indicates a right-left direction (vehicle width direction) as viewed from a driver seat, and a term “up-down” indicates an up-down direction when the vehicle stands still on a horizontal plane.

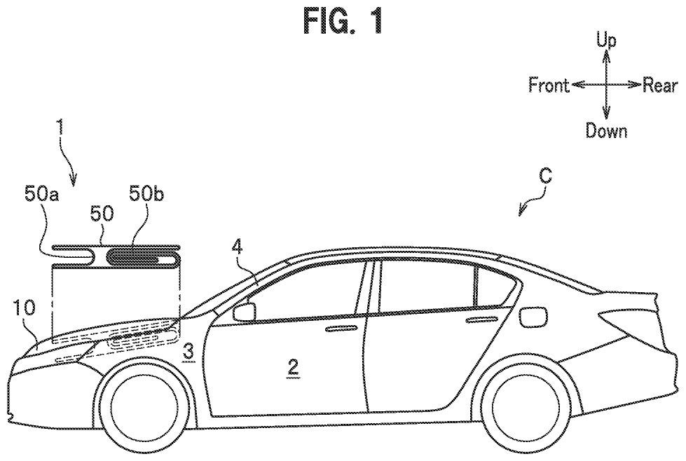

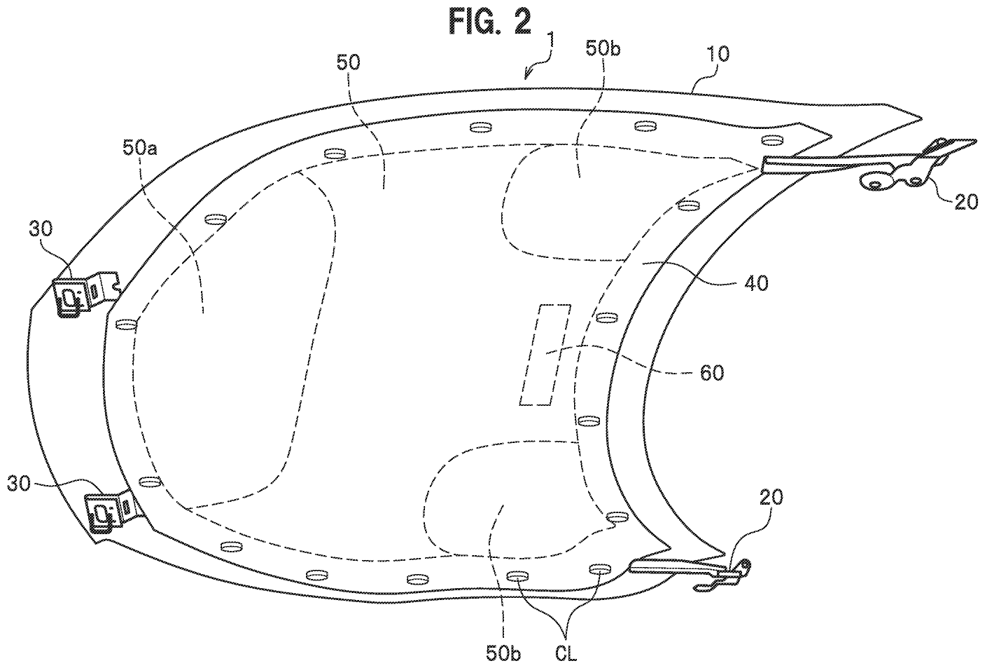

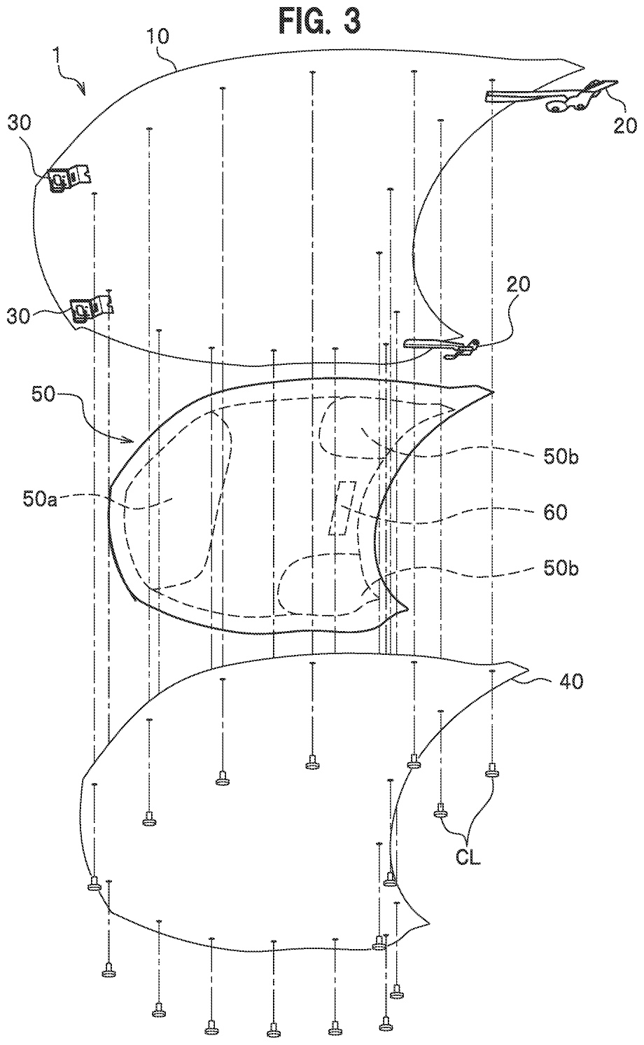

As shown in FIG. 1, an airbag arrangement structure 1 according to the embodiment of the present invention is applied to a hood 10 configured to open or close an opening above an engine room 3 in front of a vehicle interior in a vehicle C. In the engine room 3, various devices (such as an engine, a motor, and a battery) are housed under the hood 10. As can be seen in FIGS. 2 and 3, the airbag arrangement structure 1 includes the hood 10, a pair of right and left hinges 20, a pair of right and left strikers 30, a cover 40, an airbag 50, and an inflator 60.

### <Hood>

The hood 10 is a plate member made of metal or resin to cover an opening above the engine room when the hood 10 is closed.

### <Hinge>

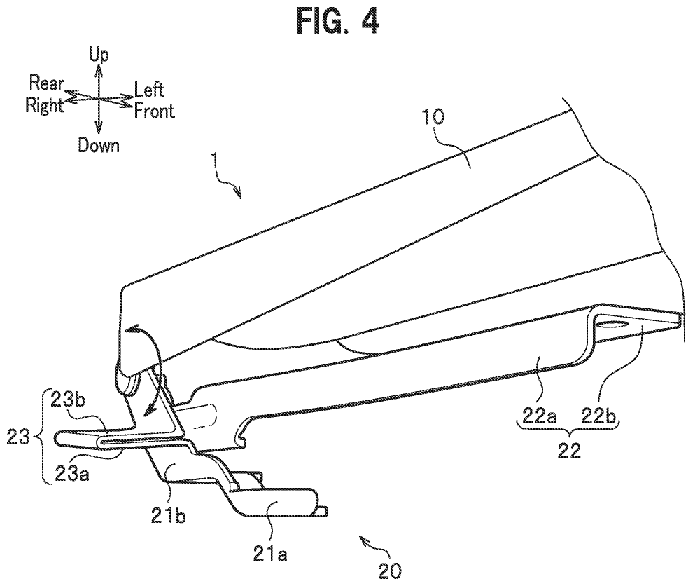

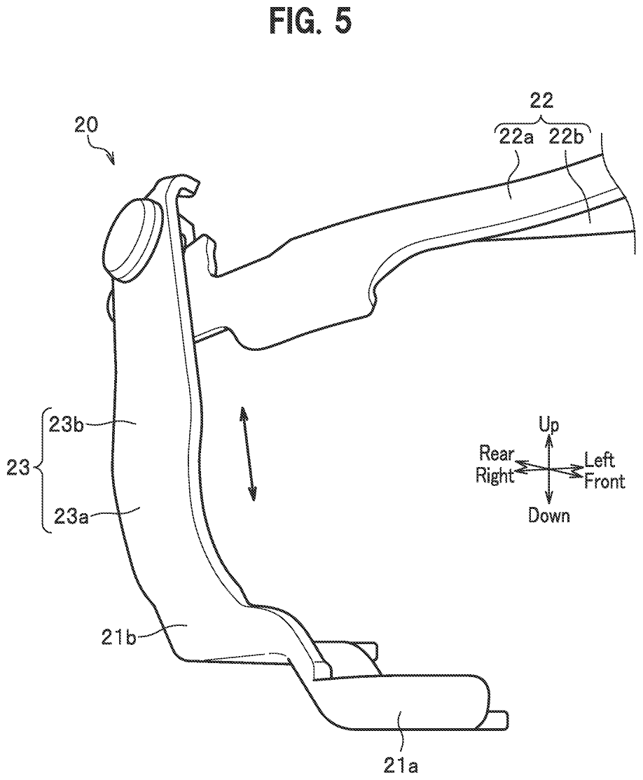

The hinge 20 is a member made of metal or resin to support a rear end of the hood 10 so as to be rotatable about a lateral axis. The pair of right and left hinges 20 is bilaterally symmetrical and thus the hinge 20 on the right side is described below. As shown in FIGS. 4 and 5, the hinge 20 includes a lower hinge 21 to be attached to a vehicle body and an upper hinge 22 to be attached to the hood 10.

The lower hinge 21 integrally includes a base 21a to be attached to the vehicle body and a vertical wall 21b extending upward from the base 21a.

The upper hinge 22 integrally includes a side wall 22a extending in the front-rear direction and an upper wall 22b extending inward in the vehicle width direction from an upper end of the side wall 22a. A rear end of the side wall 22a is rotatably supported with respect to an upper end of the vertical wall 21b of the lower hinge 21. A front end of the upper wall 22b is fixed to an under surface of the hood 10.

### <<Deformity>>

The vertical wall 21b of the lower hinge 21 has a deformity 23. The deformity 23 integrally includes a bottom wall 23a extending outward in the vehicle width direction from an upper end of a lower portion of the vertical wall 21b, and a top wall 23b folded upward from an outer end in the vehicle width direction of the bottom wall 23a to extend inward in the vehicle width direction. An inner end in the vehicle width direction of the top wall 23b continues to a lower end of an upper portion of the vertical wall 21b. The deformity 23 is not deformed by normal open/close of the hood 10 as well as a load inputted at a front collision of the vehicle C, but is deformed by a deploying force (inflating force) of the airbag 50 so as to be stretched in the up-down direction.

### <Striker>

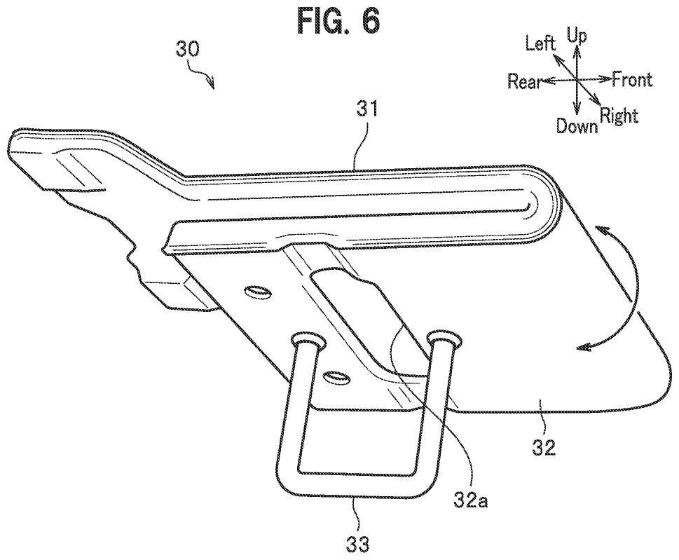

As shown in FIGS. 2 and 3, the striker 30 is a member made of metal or resin to lock a front end of the hood 10. The pair of right and left strikers 30 is bilaterally symmetrical and thus the striker 30 on the right side is described below. Note that the single striker 30 may be provided at a center in the vehicle width direction of the front end of the hood 10 instead of the pair of right and left strikers 30, As shown in FIG. 6, the striker 30 integrally includes a top wall 31 to be fixed to the under surface of the hood 10, a bottom wall 32 folded downward from a rear end of the top wall 31 to extend frontward, and a locked part 33 in a U-shape extending downward from the bottom wall 32. The locked part 33, when locked, is locked with a latch of a locking device of the vehicle body. The bottom wall 32 is formed with an access hole 32a used when the top wall 31 is fixed by bolts or the like to the hood 10.

### <Cover>

As shown in FIGS. 2 and 3, the cover 40 is a plate member made of heat-resistant woven fabric disposed to face the under surface of the hood 10. The cover 40 is fixed to the hood 10 by clips CL. The cover 40 has functions of suppressing noises from various devices (such as an engine) in the engine room 3 to the outside of the vehicle, as well as protecting, and preventing heat damage to, the airbag 50.

### <Airbag>

The airbag 50 is disposed between the hood 10 and the cover 40. A front end 50a of the retracted airbag 50 is folded so as to be pushed into the airbag 50. In addition, a pair of right and left horn portions 50b at a rear end of the retracted airbag 50 is folded so as to be pushed into the airbag 50. A front end of the horn portion 50b may be further folded or wound. A top surface or under surface of the airbag 50 may be fixed to the under surface of the hood 10 or a top surface of the cover 40, such as by hooking an engaged part of the airbag 50 in an annular shape onto a projection from a member to which the airbag 50 is attached.

### <Inflator>

The inflator 60 fills air into the airbag 50 to deploy the airbag 50. The inflator 60 is provided on the hood 10 near a rear end inside the airbag 50, that is, near an axis of rotation of the hood 10 on the hinges 20.

### <Relationship Between Cover and Retracted Airbag>

When the airbag 50 is retracted, the hood 10 and the cover 40 have a larger area, in planar view, than the airbag 50. In other words, the retracted airbag 50 has a smaller area, in planar view, than the hood 10 and cover 40, so that the hood 10 and the cover 40 each have a part of periphery thereof not overlapping or underlapping with the airbag 50 in planar view. The cover 40 is fixed to the hood 10 at such a part of the periphery.

### <Behavior at Deployment>

When the inflator 60 is activated, the airbag 50 is deployed and the cover 40 is separated from the hood 10 by a deployment force of the airbag 50. The cover 40 separated from the hood 10 is placed over the various devices in the engine room 3. The airbag 50 is deployed (inflated) upward in a state of contacting the top surface of the cover 40. The deformity 23 of the hinge 20 is deformed by the deployment force of the airbag 50 so as to be stretched in the up-down direction (from a state in FIG. 4 to a state in FIG. 5). Likewise, the strikers 30 are each deformed so as to stretch the folded portion between the top wall 31 and the bottom wall 32. This causes the hood 10 in a closed state to be raised by the deployment force of the airbag 50 and supported by the deploying airbag 50. In addition, the front end 50a of the airbag 50 extends ahead of the front end of the hood 10, and the pair of right and left horn portions 50b at the rear end of the airbag 50 extends so as to cover front pillars 4 (see FIG. 1) of the vehicle C from ahead.

The airbag arrangement structure 1 according to the embodiment of the present invention includes: the hood 10 configured to open or close the opening above the engine room 3 provided in front of a vehicle interior 2; the cover 40 provided under the hood 10 so as to face the hood 10; and the airbag 50 provided between the hood 10 and the cover 40, Accordingly, the airbag arrangement structure 1 uses the cover 40 to prevent the deploying airbag 50 from having interference from devices in the engine room 3. In addition, the airbag arrangement structure 1 uses the cover 40 to implement the functions of suppressing noises from the various devices (such as engine) in the engine room 3 to the outside of the vehicle, and preventing heat damage to the airbag 50.

Further, the airbag arrangement structure 1 includes the hinge 20 to support the hood 10 so as to be opened or closed with respect to the vehicle body, wherein the hinge 20 has the deformity 23 deformable in the up-down direction by the deployment force of the airbag 50, and the deployed airbag 50 supports the hood 10. Accordingly, the airbag arrangement structure 1 suitably lifts and supports a portion of the hood 10, working as the axis of rotation at normal open/close of the hood 10, by the deployment force of the airbag 50, and even when something collides against a portion of the hood 10 near the hinge 20, the hinge 20 is deformed so as to be contracted, to provide capability of protecting something colliding against the hood 10 more evenly all over the hood 10.

Still further, the cover 40 of the airbag arrangement structure 1 has a larger area, in planar view, than the retracted airbag 50. Accordingly, the airbag arrangement structure 1 is allowed for suitably securing a margin for fixing the cover 40 to the hood 10.

Still further, the deployed airbag 50 of the airbag arrangement structure 1 extends from the front end to rear end of the hood 10. Accordingly, the airbag arrangement structure 1 lifts the hood 10 end to end in the front-rear direction, to provide capability of protecting something colliding against the hood 10 evenly in the front-rear direction.

Still further, the airbag arrangement structure 1 includes the hinge 20 to support the hood 10 so as to be opened or closed with respect to the vehicle body, and the inflator 60 to deploy the airbag 50 is provided on the hood 10 near the axis of rotation of the hood 10 by the hinges 20. Accordingly, the airbag arrangement structure 1 allows for reducing an impact on the inflator 60 at normal open/close of the hood 10.

Hereinabove, the embodiment of the present invention has been described, but the present invention is not limited thereto and can be modified as required within the scope of the present invention. For example, the front end 50a of the deployed airbag 50 may cover the front end of the vehicle C from ahead. In addition, the deformity 23 of the hinge 20 may have the folded portion, between the bottom wall 23a and top wall 23b, positioned inside in the vehicle width direction with respect to the vertical wall 21b. Further, the hood 10 may be lifted not by the deploying force of the airbag 50 but a separate actuator (not shown), or a combination of the deploying force of the airbag 50 and such an actuator.

### LIST OF REFERENCE SIGNS

1: airbag arrangement structure, 10: hood, 20: hinge, 23: deformity, 40: cover, 50: airbag, and 60: inflator.

What is claimed is:

1. An airbag arrangement structure comprising:
a hood configured to open or close an opening above an engine room provided in front of a vehicle interior;
a cover provided under the hood so as to face the hood; and
an airbag provided between the hood and the cover.

2. The airbag arrangement structure as claimed in claim 1, further comprising:
a hinge to support the hood so as to be opened or closed with respect to a vehicle body,
wherein the hinge has a deformity deformable in an up-down direction by a deployment force of the airbag, and
the deployed airbag supports the hood.

3. The airbag arrangement structure as claimed in claim 1, wherein
the cover has a larger area, in planar view, than the retracted airbag.

4. The airbag arrangement structure as claimed in claim 1, wherein
the deployed airbag extends from a front end to a rear end of the hood.

5. The airbag arrangement structure as claimed in claim 1, further comprising:
a hinge to support the hood so as to be opened or closed with respect to a vehicle body,
wherein an inflator to deploy the airbag is provided on the hood near an axis of rotation of the hood on the hinge.
